(19) United States
(12) Patent Application Publication
(10) Pub. No.: US 2018/0083282 A1
(43) Pub. Date: Mar. 22, 2018

(54) CARBONACEOUS MOLDED BODY FOR BATTERY ELECTRODE AND METHOD OF MANUFACTURING SAME

(71) Applicant: Kureha Corporation, Tokyo (JP)

(72) Inventors: Takanori BABA, Tokyo (JP); Choi YOUNG-KUK, Tokyo (JP); Shota KOBAYASHI, Tokyo (JP); Yasuhiro TADA, Tokyo (JP)

(21) Appl. No.: 15/562,152

(22) PCT Filed: Mar. 28, 2016
(86) PCT No.: PCT/JP2016/059832

§ 371 Date: Sep. 27, 2017

(30) Foreign Application Priority Data
Mar. 27, 2015 (JP) 2015-067561

(51) Int. Cl. H01M 4/587; H01M 4/133; H01M 10/05; H01M 4/04

(52) U.S. Cl. CPC H01M 4/587; H01M 4/133; H01M 2004/027; H01M 4/04; H01M 4/0471; H01M 10/05

(57) ABSTRACT

An object of the present invention is to provide a carbonaceous molded body for a battery electrode having high charge/discharge capacity, high initial charge/discharge efficiency, and excellent cycle life. The aforementioned object can be achieved by a carbonaceous molded body for a battery electrode of the present invention, including: carbon fibers where lithium can be doped and dedoped; and a carbonaceous material; wherein the thickness is 1 mm or less, atomic ratio (H/C) between hydrogen atoms and carbon atoms based on elemental analysis is 0.1 or less, porosity determined from bulk density of the molded body and true density of butanol is from 25 to 80%, and volatile matter content is 5.0 wt. % or less.

### TECHNICAL FIELD

The present invention relates to a carbonaceous molded body for a battery electrode and manufacturing method thereof. A secondary battery demonstrating excellent efficiency can be obtained by the present invention.

### BACKGROUND ART

In recent years, in applications of non-aqueous electrolyte secondary batteries in small portable devices such as mobile telephones or laptop computers, the capacity per unit volume is important, and therefore, graphitic materials with high density have been primarily used as anode active materials.

On the other hand, the concept of mounting a large lithium-ion secondary battery, having high energy density and excellent output characteristics, in an electric automobile has been investigated in response to increasing concern over environmental issues. However, lithium-ion secondary batteries for vehicles are large and expensive, and are thus difficult to replace. Therefore, at least the same durability as the automobile is required, and a lifetime performance of 10 years or longer (high durability) is required.

Not only are high-performance lithium-ion secondary batteries used as power sources in small portable devices and next-generation vehicles such as electric and hybrid automobiles, the batteries are also used in energy storage for power peak shifting, stabilizing renewable energy, or the like. In other words, lithium-ion secondary batteries are used in a variety of applications, and therefore, the required performance of a lithium-ion secondary battery differs greatly depending on application.

When applications are classified according to the scale of lithium-ion secondary batteries, four typical applications are considered: “system,” “industrial,” “medium-scale grid,” and “residential”. “System” applications include cases where lithium-ion secondary batteries are installed in a large-scale photovoltaic power plant (so-called megasolar), a wind power plant, or the like, and cases installed in a substation or the like. In “industrial” applications, lithium-ion secondary batteries are installed in factories, commercial facilities, large-scale housing complexes, or the like, or are used for surplus power storage of renewable energy or storage for power peak shifting. In “medium-scale grid” applications, lithium-ion secondary batteries are installed in schools, urban areas, buildings, or housing complexes. In “residential” applications, small storage batteries are installed in individual residences.

In the field of small portable devices, the demand for high capacity, high durability, and reduced manufacturing cost increases as devices increase in functionality. On the other hand, in the field of large-scale batteries, the demand for high durability, high reliability, and reduced manufacturing cost is high. In order to satisfy these requirements for lithium-ion secondary batteries, high charge/discharge capacity, high coulombic efficiency, high durability, reduced electrode resistance, and reduced cost are anticipated in anode materials.

The following manufacturing method has been widely used as a method of manufacturing anodes of conventional general lithium-ion secondary batteries. A binder is added to an anode active material and dissolved using an organic solvent or water. An additive such as a conductive agent or the like is added if necessary, and the obtained mixture is kneaded to form a slurry. One or both surfaces of a metal foil current collector formed from copper, nickel, or the like is coated with the slurry by a doctor blading method or the like. This is dried, and then formed into an electrode by pressure molding. Furthermore, the obtained electrode is cut to a predetermined width and length, and laminated along with a cathode and a separator, and then an electrolyte is added to obtain a lithium-ion secondary battery.

High cost manufacturing equipment and a complicated process are required in manufacturing anodes in the lithium-ion secondary batteries. Furthermore, homogeneity in the electrode coating greatly influences fluctuations in battery performance, and the speed of the coating step and drying step greatly influences the battery production capacity. Therefore, if the electrode preparing process in the battery manufacturing process can be simplified, not only would quality stability and battery mass productivity be drastically improved, but reduced battery manufacturing cost can also be expected.

### CITATION LIST

### Patent Literature

Patent Literature 1: JP 09-92283 A

Patent Literature 2: JP 2009-146580 A

### SUMMARY OF INVENTION

### Technical Problem

Conventional lithium-ion secondary batteries have problems where charge/discharge capacity is low, initial charge/discharge efficiency is low, charge/discharge speed is slow, and cycle life is short.

In order to resolve the aforementioned problems, Patent Literature 1 discloses a paper-like lithium secondary battery anode where short carbon fibers are used as a framework, spaces between the fibers are filled with a powdered carbon material such as milled carbon fibers or the like, and PET fibers are used as a binder.

Patent Literature 2 discloses an anode active material sheet for a lithium-ion secondary battery where vapor-grown carbon fibers are added to carbonaceous particles that dope and dedope lithium ions and a fired carbonized material that binds the carbonaceous particles. However, secondary batteries using the anodes did not demonstrate sufficient charge/discharge capacity.

An object of the present invention is to provide a carbonaceous molded body for a battery electrode having high charge/discharge capacity, high initial charge/discharge efficiency, and excellent cycle life. In other words, an object of the present invention is to provide a carbonaceous molded body for a battery electrode having high electrode electrical conductivity as an anode for a battery. Furthermore, another object of the present invention is to provide an efficient method for manufacturing an anode.

### Solution to Problem

As a result of extensive studies on carbonaceous molded bodies for a battery electrode having high charge/discharge capacity, high initial charge/discharge efficiency, and excellent cycle life, the present inventors unexpectedly discovered that a carbonaceous molded body for a battery electrode containing a carbonaceous material and carbon fibers having specific physical properties, and particularly ionic conductivity, and having a porosity of 25 to 80% and a volatile matter content of 5 wt. % or less exhibits excellent efficiency.

The present invention is based on this knowledge.

Therefore, the present invention relates to:

[1] a carbonaceous molded body for a battery electrode, including: a carbonaceous material and carbon fibers where lithium can be doped and dedoped; where the thickness is 1 mm or less, atomic ratio (H/C) between hydrogen atoms and carbon atoms based on elemental analysis is 0.1 or less, porosity determined from bulk density of the molded body and true density of butanol is 25 to 80%, and volatile matter content is 5.0 wt. % or less;
[2] the carbonaceous molded body for a battery electrode according to [1], where the carbonaceous material is a non-graphitizable carbonaceous material;
[3] the carbonaceous molded body for a battery electrode according to [1] or [2], where the carbonaceous material is a graphitizable carbonaceous material;
[4] the carbonaceous molded body for a battery electrode according to any one of [1] to [3], further including one or more anode active material selected from the group consisting of metals that can dope and dedope lithium and metal compounds that can dope and dedope lithium;
[5] the carbonaceous molded body for a battery electrode according to any one of [1] to [4], where true density is from 1.4 to 2.20 g/cm³;
[6] the carbonaceous molded body for a battery electrode according to any one of [1] to [5], where at least one combustion peak is observed at 760° C. or lower as measured by a differential thermal analyzing device;
[7] the carbonaceous molded body for a battery electrode according to any one of [1] to [6], where the carbon fibers have an isotropic structure;
[8] an electrode for a battery, including the carbonaceous molded body for a battery electrode according to any one of [1] to [7];
[9] a non-aqueous electrolyte secondary battery, including the electrode for a battery according to [8];
[10] a method of manufacturing a carbonaceous molded body for a battery electrode, including the steps of: (1) mixing carbon fibers and or a carbon fiber precursor thereof where lithium can be doped and dedoped, and a carbonaceous precursor to obtain a mixture; (2) molding the mixture to obtain a molded body; and (3) firing in order to heat treat the molded body under a non-oxidizing gas atmosphere at 1000° C. to 2000° C.;
[11] the method of manufacturing a carbonaceous molded body for a battery electrode according to [10], where the carbonaceous precursor is a non-graphitizable carbonaceous precursor and/or graphitizable carbonaceous precursor;
[12] the method of manufacturing a carbonaceous molded body for a battery electrode according to [10] or [11], where in the aforementioned step 1, one or more anode active materials selected from the group consisting of metals that can dope and dedope lithium and metal compounds that can dope and dedope lithium is further mixed;
[13] the method of manufacturing a carbonaceous molded body for a battery electrode according to any one of [10] to [12], where the molded body in the aforementioned molding step (2) is obtained by compression molding; and
[14] the method of manufacturing a carbonaceous molded body for a battery electrode according to any one of [10] to [13], where the carbon fibers have an isotropic structure.

### Advantageous Effects of Invention

The carbonaceous molded body for a battery electrode of the present invention includes a carbonaceous material and carbon fibers where lithium can be doped and dedoped, and by controlling the porosity of the carbonaceous molded body for a battery electrode, a non-aqueous solvent secondary battery can be obtained, having high discharge capacity relative to charge capacity and low irreversible capacity, and thus having high charge/discharge efficiency.

Furthermore, the carbonaceous molded body for a battery electrode of the present invention contains almost no polymeric binder having low electrical conductivity. Therefore, by using the carbonaceous molded body for a battery electrode as an anode material such as a non-aqueous solvent secondary battery (for example, a lithium ion secondary battery), an increase in overvoltage caused by contact resistance of active material particles can be suppressed. Furthermore, contact resistance does not increase, and therefore, charging/discharging with high current density are possible without the overvoltage of the electrode increasing. Furthermore, overvoltage does not increase, and therefore, safety is increased without decomposition or heat build-up of the electrolyte. Furthermore, the binder may swell up and separate from the current collector due to the non-aqueous solvent configuring the electrolyte. Furthermore, the carbonaceous molded body for a battery electrode of the present invention does not include a polymeric binder, and therefore, swelling due to a non-aqueous solvent does not occur. Therefore, excellent durability can be achieved without an anode peeling from a current collector.

Furthermore, the carbonaceous molded body for a battery electrode of the present invention is used as an anode material, and therefore, a process of coating an electrode current collector with an active material, which requires high skill, is not required, and thus a battery manufacturing process can be simplified.

Furthermore, with the carbonaceous molded body for a battery electrode including a non-graphitizable carbonaceous material of the present invention, a secondary battery having high discharge capacity per unit weight can be obtained. Furthermore, with the carbonaceous molded body for battery electrode including a graphitizable carbonaceous material of the present invention, electrode density increases, and thus a secondary battery having high discharge capacity per unit volume can be obtained. Furthermore, a secondary battery that uses the carbonaceous molded body for a battery electrode including a metal or the like capable of lithium doping and dedoping of the present invention has very high charge/discharge capacity. Furthermore, the carbonaceous molded body for a battery electrode of the present invention can also be used in a battery other than a non-aqueous solvent secondary battery, and when used in an all-solid-state secondary battery for example, the same effects as in a non-aqueous solvent secondary battery can be obtained. The metal or metal compound capable of lithium doping and dedoping readily expands and contracts due to charging and discharging, but in the carbonaceous molded body for a battery electrode of the present invention, the swelling and contraction can be suppressed, and thus use is possible as an electrode demonstrating safety and excellent charge/discharge capacity and efficiency.

### DESCRIPTION OF EMBODIMENTS

### [1] Carbonaceous Molded Body for Battery Electrode

A carbonaceous molded body for a battery electrode of the present invention includes: a carbonaceous material and carbon fibers where lithium can be doped and dedoped; wherein the thickness is 1 mm or less, atomic ratio (H/C) between hydrogen atoms and carbon atoms based on elemental analysis is 0.1 or less, porosity determined from bulk density of the molded body and true density of butanol is from 25 to 80%, and volatile matter content is 5.0 wt. % or less. The carbonaceous molded body for a battery electrode of the present invention preferably has a true density of 1.4 to 2.20 g/cm³. Furthermore, the carbonaceous molded body for a battery electrode of the present invention preferably has at least one combustion peak at 760° C. or lower as measured by differential thermal analysis. The carbonaceous material is preferably a non-graphitizable carbonaceous material and/or graphitizable carbonaceous material, and the carbonaceous molded body for a battery electrode of the present invention may include graphite. Furthermore, the carbonaceous molded body for a battery electrode of the present invention can include one or more anode active materials selected from the group consisting of metals capable of lithium doping and dedoping and metal compounds capable of lithium doping and dedoping. In the present specification, “amorphous carbon” or “turbostratic structure carbon” refers to non-graphitizable carbon and graphitizable carbon. In other words, in the present specification, non-graphitic material that does not have a graphite structure is referred to as amorphous carbon or turbostratic structure carbon.

### Thickness of Carbonaceous Molded Body for Battery Electrode

The thickness of the carbonaceous molded body for a battery electrode of the present invention is 1 mm or less. When the carbonaceous molded body for a battery electrode is thick, the distance from a molded body surface to a current collector is large, which leads to increased electrode resistance, if used as an anode. Therefore, an upper limit of the molded body thickness is 1 mm or less, preferably 0.8 mm or less, and more preferably 0.7 mm or less. On the other hand, as the thickness the carbonaceous molded body for a battery electrode is reduced, electrode resistance, and thus rapid charging and discharging are possible. Therefore, a lower limit of the carbonaceous molded body for a battery electrode thickness is not limited. However, when the thickness of the carbonaceous molded body for a battery electrode is thin, the used amounts of current collector and separator may increase, and the volume energy density of the non-aqueous solvent secondary battery may decrease. Therefore, the lower limit of molded body thickness is 0.01 mm or greater, preferably 0.1 mm or greater, and more preferably 0.2 mm or greater.

### Bulk Density of Carbonaceous Molded Body for Battery Electrode

The bulk density of the carbonaceous molded body for a battery electrode of the present invention is not limited, but is preferably from 0.20 to 1.40 g/cm³, more preferably from 0.30 to 1.40 g/cm³, even more preferably from 0.30 to 1.30 g/cm³, and most preferably from 0.40 to 1.30 g/cm³. If the bulk density is from 0.20 to 1.40 g/cm³, a carbonaceous molded body for a battery electrode having high charge/discharge efficiency is obtained.

However, the bulk density of the carbonaceous molded body for a battery electrode including a metal that can dope and dedope lithium or a metal compound that can dope or dedope lithium (hereinafter, may be referred to as metal anode material) may exceed 1.40 g/cm³. The bulk density of the carbonaceous molded body for a battery electrode including a metal anode material is not limited, but is preferably from 0.20 to 2.25 g/cm³, more preferably from 0.30 to 2.25 g/cm³, even more preferably from 0.35 to 2.20 g/cm³, and most preferably from 0.40 to 2.20 g/cm³. If the bulk density is from 0.20 to 2.25 g/cm³, a molded body having excellent charge/discharge efficiency is obtained. The bulk density of the carbonaceous molded body for a battery electrode is a value obtained by dividing the mass of the carbonaceous molded body for a battery electrode by the volume (area×thickness) determined from the exterior dimensions of the carbonaceous molded body for a battery electrode. In other words, the bulk density of the carbonaceous molded body for a battery electrode refers to the mass per unit volume including open pores (cavities that pass through to open air) and closed pores (cavities isolated inside). When the bulk density is less than 0.20 g/cm³, the quantity of electricity that can be stored per unit volume may decrease.

### Specific Surface Area of Carbonaceous Molded Body for Battery Electrode

The specific surface area (hereinafter, may be referred to as “SSA”) of the carbonaceous molded body for a battery electrode of the present invention, determined by a BET method of nitrogen adsorption is not limited, but is preferably from 0.01 to 20 m²/g. An upper limit of specific surface area is preferably 15 m²/g or less, more preferably 10 m²/g or less, and most preferably 5 m²/g or less. When the SSA exceeds 20 m²/g, an irreversible capacity of the obtained battery may increase. Furthermore, a lower limit of specific surface area is preferably 0.05 m²/g or greater, more preferably 0.1 m²/g or greater, and most preferably 0.5 m²/g or greater. When the SSA is less than 0.01 m²/g, the discharge capacity of the obtained battery may be reduced.

### Atomic Ratio (H/C) of Carbonaceous Molded Body for Battery Electrode

The H/C ratio of the carbonaceous molded body for a battery electrode of the present invention can be calculated from a value measuring the amount of hydrogen atoms and carbon atoms by elemental analysis. As the degree of carbonization of a carbonaceous material increases, the hydrogen content decreases, and therefore, the H/C ratio tends to decrease. Therefore, the H/C ratio is effective as an index expressing the degree of carbonization. The H/C ratio of the carbonaceous molded body for a battery electrode of the present invention is 0.1 or less, more preferably 0.08 or less, and even more preferably 0.05 or less. When the H/C ratio of hydrogen atoms to carbon atoms exceeds 0.1, the amount of functional groups present in the carbonaceous material increases, and thus the irreversible capacity may increase due to a reaction with lithium.

### True Density of Carbonaceous Molded Body for Battery Electrode

The true density of a molded body having an ideal graphite structure is 2.27 g/cm³, and the true density tends to decrease as the crystal structure becomes disordered. Therefore, the true density can be used as an index expressing the carbon structure. The true density of the carbonaceous molded body for a battery electrode of the present invention is preferably from 1.4 to 2.20 g/cm³, and the lower limit is more preferably 1.45 g/cm³ or greater, even more preferably 1.50 g/cm³ or greater, yet even more preferably 1.55 g/cm³ or greater, and yet even more preferably 1.56 g/cm³ or greater. Furthermore, an upper limit of the true density is preferably 2.20 g/cm³ or less, more preferably 2.15 g/cm³ or less, and even more preferably 2.10 g/cm³ or less. A carbonaceous molded body for a battery electrode having a true density that is less than 1.4 g/cm³ may have a large number of closed pores, and the doping and dedoping capacity may be reduced, which is not preferable. Furthermore, the electrode density decreases, thereby causing a reduction in volume energy density, which is not preferable. Furthermore, when the true density exceeds 2.20 g/cm³, the crystallinity of the carbonaceous molded body for a battery electrode may increase, the proportion of edge surfaces may be reduced, and the input/output performance may be reduced. Furthermore, when the true density exceeds 2.20 g/cm³, high-temperature cycle characteristics may be inferior if the carbonaceous molded body for a battery electrode of the present invention is used in a battery.

Furthermore, the true density of the carbonaceous molded body for a battery electrode including a non-graphitizable carbonaceous material (but not including a metal anode material) is preferably from 1.4 to 1.85 g/cm³. A lower limit is more preferably 1.45 g/cm³ or greater, even more preferably 1.50 g/cm³ or greater, yet even more preferably 1.55 g/cm³ or greater, and yet even more preferably 1.56 g/cm³ or greater. An upper limit is less than 1.85 g/cm³, more preferably 1.70 g/cm³ or less, and even more preferably 1.60 g/cm³ or less. The carbonaceous molded body for a battery electrode of the present invention having a true density of 1.4 to 1.85 g/cm³ can achieve a high discharge capacity per unit weight.

Furthermore, the true density of a carbonaceous molded body for a battery electrode including large amount of graphitizable carbonaceous material (but not including a metal anode material) is preferably from 1.85 to 2.20 g/cm³, where the lower limit is preferably 1.88 g/cm³ or greater, and more preferably 1.90 g/cm³ or greater. The upper limit is preferably 2.20 g/cm³ or less, more preferably 2.15 g/cm³ or less, and even more preferably 2.10 g/cm³ or less. With the carbonaceous molded body for a battery electrode of the present invention having a true density of 1.85 to 2.20 g/cm³, electrode density can be increased and a secondary battery having high discharge capacity per unit volume can be obtained.

A lower limit of true density of a carbonaceous molded body for a battery electrode including a metal anode material is not limited, but is 1.51 g/cm³ or greater, preferably 1.70 g/cm³ or greater, more preferably 1.80 g/cm³ or greater, and even more preferably 1.90 g/cm³ or greater. An upper limit is preferably 3.00 g/cm³ or less, more preferably 2.90 g/cm³ or less, and even more preferably 2.80 g/cm³ or less. If 3.00 g/cm³ is exceeded, the proportion of metal or metal compound capable of doping and dedoping lithium is high and metal expansion/contraction is high, and thus durability may be reduced.

Note that methods of measuring the true density include a pycnometer method using butanol, a density gradient tube method, and a method of measuring dry density using helium, but the true density of the carbonaceous molded body for a battery electrode in the present specification refers to a true density obtained by the pycnometer method using butanol. Note that when the carbonaceous molded body for a battery electrode of the present invention is configured from a plurality of carbon materials having different structures, the carbon materials respectively exhibit different true densities due to differences in the structures thereof. However, for the true density of the carbonaceous molded body for a battery electrode of the present invention, a true density value measured by the pycnometer method using the molded body as a whole is set as the true density of the molded body, even if a mixture of carbon materials of different structures are present in the carbonaceous molded body for a battery electrode.

### Porosity of Carbonaceous Molded Body for Battery Electrode

The porosity of a carbonaceous molded body for a battery electrode including a turbostratic structure carbonaceous material of the present invention is from 15 to 80%, preferably from 15 to 70%, more preferably from 15 to 60%, and most preferably from 18 to 55%. In particular, the porosity of a carbonaceous molded body for a battery electrode including a turbostratic structure carbonaceous material of the present invention (but not including a metal anode material) is preferably from 18 to 80%, more preferably from 18 to 70%, even more preferably from 18 to 60%, and most preferably from 20 to 50%. Furthermore, the porosity of a carbonaceous molded body for a battery electrode including a metal anode material of the present invention is from 15 to 80%, preferably from 15 to 70%, more preferably from 15 to 60%, even more preferably from 18 to 55%, and most preferably from 20 to 50%. Cavities in the carbonaceous molded body for a battery electrode of the present invention are filled with electrolyte if the carbonaceous molded body is used as a non-aqueous electrolyte secondary battery. When the porosity is low, the movement speed of lithium ions in the electrolyte may decrease and ionic conductivity may decrease. On the other hand, when the porosity is too high, the strength of the electrode molded body decreases and the volume energy density of the molded body as an electrode decreases, which are not preferable.

The pore volume of the carbonaceous molded body of the present invention is not particularly limited. However, a pore volume of pores with a 0.05 to 100 μm diameter is preferably from 0.27 to 1.0 mL/g. When the pore volume of pores with a 0.05 to 100 μm diameter is low, the movement speed of lithium ions in the electrolyte may decrease and ionic conductivity may decrease. On the other hand, when the pore volume of pores with a 0.05 to 100 μm diameter is too high, the strength of the electrode molded body decreases and volume energy density of the molded body as an electrode decreases, which are not preferable. Basically, the porosity and pore volume of pores with a 0.05 to 100 μm diameter correlated. Furthermore, the pore volume of pores with a 0.01 to 0.05 μm diameter in the carbonaceous molded body of the present invention is very low, and therefore, the lower limit is not limited, but the upper limit is preferably 0.1 mL/g or less, more preferably 0.05 mL/g or less, and even more preferably 0.01 mL/g or less.

### Volatile Content of Carbonaceous Molded Body for Battery Electrode

The volatile matter content of the carbonaceous molded body for a battery electrode of the present invention is 5 wt. % or less, preferably 4 wt. % or less, and more preferably 3 wt. % or less. The conductivity of a carbon material increases as volatile matter content decreases, and therefore, the amount of volatile matter content can be used as an index of conductivity of the carbonaceous molded body for a battery electrode. Furthermore, when a polymeric binder having low conductivity is used, a large amount of volatile matter content is detected, and therefore, the content ratio of the polymeric binder can be measured by measuring the amount of volatile matter content.

### Differential Thermal Analysis of Carbonaceous Molded Body for Battery Electrode

The carbonaceous molded body for a battery electrode of the present invention is not limited, but preferably has at least one combustion peak that is 760° C. or lower as measured by a differential thermal analysis. The combustion peak as measured by differential thermal analysis correlates with the firing temperature of the carbonaceous molded body for a battery electrode of the present invention. A carbonaceous molded body for a battery electrode fired at 2000° C. or lower has a combustion peak that is 760° C. or lower, and when the firing temperature is reduced, the combustion peak of differential thermal analysis is also reduced. The combustion peak by differential thermal analysis of the carbonaceous molded body for a battery electrode of the present invention is preferably 750° C. or lower, more preferably 740° C. or lower, even more preferably 730° C. or lower, yet even more preferably 720° C. or lower, yet even more preferably 710° C. or lower, and yet even more preferably 700° C. or lower.

### Firing Temperature of Carbonaceous Molded Body for Battery Electrode

The carbonaceous molded body for a battery electrode of the present invention is not limited, but is preferably obtained by firing at 1000 to 2000° C. The carbonaceous molded body for a battery electrode including a metal anode material is particularly preferably obtained by firing at 1000 to 2000° C. By firing at 1000 to 2000° C., an optimal H/C ratio is obtained, and an increase in irreversible capacity due to a reaction with lithium can be suppressed. Furthermore, firing at the aforementioned temperature can prevent selective orientation of the carbon hexagonal plane from overly increasing, and can prevent discharge capacity from decreasing.

### Average Interlayer Separation of Carbonaceous Molded Body for Battery Electrode

The average interlayer separation of the (002) plane determined by powder X-ray diffraction on the carbonaceous material that is one of the constituent materials of the carbonaceous molded body for a battery electrode of the present invention exhibits a value that decreases as crystal perfection increases. The average interlayer separation of an ideal graphite structure exhibits a value of 0.3354 nm, and the value tends to increase as disorder of the structure increases. Therefore, the average interlayer separation is effective as an index indicating the carbon structure. The average interlayer separation of the (002) plane of the turbostratic structure carbonaceous material included in the carbonaceous molded body for a battery electrode of the present invention is not limited, but is 0.336 nm or greater, preferably 0.340 nm or greater, more preferably 0.345 nm or greater, and even more preferably 0.365 nm or greater. In particular, the average interlayer separation of the (002) plane of a carbonaceous molded body for a battery electrode including a metal capable of lithium doping and dedoping and/or a metal compound capable of lithium doping and dedoping (metal anode material) is 0.336 nm or greater, preferably 0.340 nm or greater, more preferably 0.345 nm or greater, and even more preferably 0.365 nm or greater. An upper limit of the average interlayer separation is 0.400 nm or less, preferably 0.395 nm or less, and more preferably 0.390 nm or less. In particular, the average interlayer separation of the (002) plane of the carbonaceous molded body for a battery electrode including a metal anode material is 0.400 nm or less, preferably 0.395 nm or less, and more preferably 0.390 nm or less. When the interlayer separation of the 002 plane is less than 0.336 nm, doping capacity is reduced if used as an anode of a non-aqueous electrolyte secondary battery, or expansion and contraction increases in accordance with doping and dedoping lithium, a gap occurs between particles, and a conductive network between the particles is blocked, and thus repeating properties are inferior, and therefore, applications in an automobile are not particularly preferable. Furthermore, when the interlayer spacing of the (002) plane exceeds 0.400 nm, non-dedoping capacity increases, which is not preferable.

### Anode Active Material

The carbonaceous molded body for a battery electrode of the present invention includes a turbostratic structure carbonaceous material (amorphous carbonaecous material) as an anode active material. Furthermore, the carbonaceous molded body for a battery electrode includes carbon fibers where lithium can be doped or dedoped, but the carbon fibers that where lithium can be doped or depoded also function as an anode active material. Furthermore, the carbonaceous molded body for a battery electrode may include one or more anode active materials selected from the group consisting of metals or metal compounds capable of lithium doping and dedoping, and may also include graphitic materials if necessary.

### Carbon Fibers Capable of Lithium Doping and Dedoping

The carbon fibers where lithium can be doped or dedoped, included in the carbonaceous molded body for a battery electrode of the present invention, is not particularly limited so long as lithium is doped and dedoped, and examples can include polyacrylonitrile-based carbon fibers, pitch-based carbon fibers, and rayon-based carbon fibers, but the pitch-based carbon fibers are preferable. Furthermore, examples of the pitch-based carbon fibers can include pitch-based carbon fibers having an isotropic structure and pitch-based carbon fibers having an anisotropic structure, but pitch-based carbon fibers having an isotropic structure are preferred.

The carbon fibers where lithium can be doped and dedoped, included in the carbonaceous molded body for a battery electrode, function as an anode material itself, and can be doped and dedoped with lithium. In other words, the carbon fibers where lithium can be doped and dedoped, used in the present invention, are considered to be ion conductor carbon fibers. In the present invention, the carbon fibers function as an anode active material, and therefore, the discharge capacity increases with regard to the charge capacity and non-dedoping capacity is reduced, and thus a non-aqueous solvent secondary battery with high charge/discharge efficiency can be obtained.

The average fiber length of the carbon fibers is not limited, but is preferably from 0.01 to 30 mm, more preferably from 0.09 to 25 mm, and even more preferably from 0.1 to 5 mm. The average fiber diameter of the carbon fibers is preferably from 0.5 to 30 μm, and more preferably from 1 to 20 μm. When the average fiber diameter of the carbon fibers is less than 1 μm, manufacturing cost may increase. Furthermore, when the average fiber length is from 1 to 30 μm, suitable capacity as an anode active material can be demonstrated. Furthermore, the true density of the carbon fibers is not limited, but is preferably from 1.4 to 1.8 g/cm³ and more preferably 1.4 to 1.7 g/cm³. The true density of the carbon fibers can be measured by a density gradient tube method.

### Non-Graphitizable Carbonaceous Material

A non-graphitizable carbonaceous material is a general term for ungraphitized carbon that does not change into a graphitic structure even when heat treated at an ultra high temperature of approximately 3000° C., but herein, a carbonaceous material having a true density that is less than 1.70 g/cm³ is referred to as a non-graphitizable carbonaceous material. The non-graphitizable carbonaceous material included in the carbonaceous molded body for a battery electrode of the present invention is not limited, but is a non-graphitizable carbonaceous material derived from a carbon precursor selected from the group consisting of pitches, thermoplastic resins, and thermosetting resins. In other words, the carbon source of the non-graphitizable carbonaceous material included in the carbonaceous molded body for a battery electrode is not limited so long a non-graphitizable carbonaceous material can be manufactured. Examples thereof include petroleum pitches, coal pitches, thermoplastic resins (such as ketone resins, polyvinyl alcohols, polyethylene terephthalates, polyacetals, polyacrylonitriles, styrene/divinylbenzene copolymers, polyimide, polycarbonates, modified polyphenylene ethers, polybutylene terephthalates, polyarylates, polysulfones, polyphenylene sulfides, polyether ether ketones, polyimide resins, fluorine resins, aramid resins, or polyamide imides), thermosetting resins (such as epoxy resins, urethane resins, urea resins, diallylphthalate resins, polyester resins, polycarbonate resins, silicon resins, polyacetal resins, nylon resins, aldehyde resins (for example, phenol resins, melamine resins, amino resins, amide resins, or furan resins). Note that petroleum pitch, coal pitch, or thermoplastic resin can be used as carbon sources of non-graphitizable carbonaceous material by infusibilizing using an oxidation treatment or the like.

The non-graphitizable carbonaceous material included in the carbonaceous molded body for a battery electrode of the present invention is not particularly limited, but may be a non-graphitizable carbon having the following physical properties, when heat treated under the same conditions as the firing conditions of a molded body including a crude starting material of a non-graphitizable carbonaceous material, for example. Furthermore, the non-graphitizable carbon precursor used in manufacturing the carbonaceous molded body for a battery electrode of the present invention may also be a non-graphitizable carbon precursor having the following physical properties when heat treated under the same conditions as the firing conditions of the molded body. The non-graphitizable carbonaceous material can be separated from the carbonaceous molded body by pulverizing the carbonaceous molded body 0.1 mm or less and then selecting an appropriate immersion liquid described in the density gradient tube method of a carbon fiber density test method (JIS R7603-1999). In other words, in the present specification, separation and identification of non-graphitizable carbonaceous material from the non-graphitizable carbonaceous material, graphitizable carbonaceous material, graphite, and the like included in the carbonaceous molded body for a battery electrode can be performed based on the true density measured using the JIS density gradient tube method.

### Specific Surface Area

The specific surface area of the non-graphitizable carbonaceous material is not particularly limited. However, an upper limit of BET specific surface area is preferably 25 m²/g or less, more preferably 20 m²/g or less, even more preferably 10 m²/g or less, and yet even more preferably 5 m²/g or less. A lower limit of BET specific surface area is not limited, but is preferably 0.005 m²/g or greater, and more preferably 0.01 m²/g or greater. If the BET specific surface area is 0.005 m²/g or greater, when the carbonaceous molded body for a battery electrode of the present invention is used as an anode, the input/output characteristics may improve due to an increase in the reaction area with the electrolyte.

### L_{c} (002)

The L_{c} of the non-graphitizable carbonaceous material is not particularly limited but is preferably 10 nm or less and more preferably 0.5 to 2 nm. When L_{c} exceeds 10 nm, multiple hexagonal carbon layers are stacked, and therefore, volume expansion and contraction associated with lithium doping and dedoping increase. When volume expansion and contraction are large, the carbon structure is destroyed, doping and dedoping of lithium are blocked, and repeating properties become inferior, which is not preferable.

### Average Interlayer Separation

The average interlayer separation of the non-graphitizable carbonaceous material is not particularly limited, but is preferably from 0.365 to 0.400 nm, more preferably from 0.378 to 0.398 nm, and even more preferably from 0.380 to 0.395 nm. With a carbonaceous material having a small average interlayer separation of less than 0.365 nm, expansion and contraction associated with lithium doping and dedoping are large, and voids form between particles, which causes a conduction network to be blocked, and thus the material may have inferior repeating properties.

### True Density

The true density of the non-graphitizable carbonaceous material can be measured by a pycnometer method using butanol, dry density measuring method using helium, or a density gradient tube method, but the true density of the non-graphitizable carbonaceous material included in the carbonaceous molded body for a battery electrode of the present invention is measured by the pycnometer method using butanol. The range of the true density is not particularly limited, but is preferably from 1.45 to 1.70 g/cm³, more preferably from 1.50 to 1.70 g/cm³, and even more preferably from 1.50 to 1.65 g/m³. When the true density is less than 1.45 g/cm³, the doping capacity and dedoping capacity per unit volume are low, which is not preferable. Furthermore, a true density that exceeds 1.70 g/cm³ means that the orderliness of the carbon crystal structure has increased, and since the average interlayer separation is small, expansion and contraction associated with lithium doping and dedoping increase, leading to reduced lithium doping capacity, which is not preferable.

### Average Particle Size

If the non-graphitizable carbonaceous material included in the carbonaceous molded body for a battery electrode of the present invention is made of particles, the average particle size is not particularly limited, but is preferably with a range of 0.1 to 30.0 μm, more preferably with a range of 3.0 to 30.0 μm, and even more preferably within a range of 4.0 to 19.0 μm.

### Graphitizable Carbonaceous Material

Graphitizable carbon is a general term for ungraphitized carbon that changes into a graphite structure when heat treated at a temperature of 2000° C. or higher, but herein, ungraphitized carbon having a true density of 1.70 g/cm³ to 2.2 g/cm³ is referred to as graphitizable carbon. The graphitizable carbonaceous material included in the carbonaceous molded body for a battery electrode of the present invention is not limited, but is a graphitizable carbonaceous material derived from a carbon precursor of a pitch or thermoplastic resin. In other words, the carbon source of the graphitizable carbonaceous material included in the carbonaceous molded body for a battery electrode is not limited so long as the graphitizable carbonaceous material can be produced, and examples can include petroleum pitch, coal pitch, petroleum coke, coal coke, intermediate phase pitch, mesocarbon microbeads, vinyl chloride-based resins, and thermoplastic resins (for example, ketone resins, polyvinyl alcohols, polyethylene terephthalates, polyacetals, polyacrylonitriles, styrene/divinylbenzene copolymers, polyimides, polycarbonates, modified polyphenylene ethers, polybutylene terephthalates, polyarylates, polysulfones, polyphenylene sulfides, polyether ether ketones, polyimide resins, fluorine resins, aramid resins, and polyamide imides). These carbon sources are those that have not been infusibilized by oxidation treatment.

The graphitizable carbonaceous material included in the carbonaceous molded body for a battery electrode of the present invention is not particularly limited, but may be a graphitizable carbonaceous material having the following physical properties when heat treated under the same conditions as the firing conditions of a molded body including a crude starting material of a graphitizable carbonaceous material, for example. Furthermore, the graphitizable carbon precursor used in manufacturing the carbonaceous molded body for a battery electrode of the present invention may also be a graphitizable carbon precursor having the following physical properties when heat treated under the same conditions as the firing conditions of the molded body. In other words, the physical properties of the graphitizable carbonaceous material are not particularly limited, but the BET specific surface area is preferably from 0.005 to 25 m²/g, the Lc is preferably 30 nm or less, the average interlayer separation is preferably from 0.340 to 0.375 nm, and the true density is preferably from 1.51 to 2.20 g/cm³. When the graphitizable carbonaceous is in particulate form, the average particle size is preferably from 0.1 to 30.0 μm. Furthermore, the graphitizable carbon precursor used in manufacturing the carbonaceous molded body for a battery electrode of the present invention may also be a graphitizable carbon precursor having the aforementioned physical properties when heat treated under the same conditions as the firing conditions of the molded body. On the other hand, in separating the non-graphitizable carbonaceous material from the carbonaceous molded body, it may be separated by the same method as separating non-graphitizable carbonaceous material from the carbonaceous molded body. In other words, in the present specification, separation and identification of graphitizable carbonaceous material from the non-graphitizable carbonaceous material, graphitizable carbonaceous material, graphite, and the like included in the carbonaceous molded body for a battery electrode can be performed based on the true density measured using the JIS density gradient tube method.

### Graphite

The graphite that can be included in the carbonaceous molded body for a battery electrode of the present invention is not limited, and can be natural graphite or artificial graphite.

The physical properties of the graphite are not particularly limited, but graphite particles having a BET specific surface area of 0.1 to 10 m²/g, an Lc of 15 nm or greater, an average interlayer separation of 0.335 to 0.340 nm, a true density of 2.20 g/cm³ or greater, and an average particle size of 0.1 to 30.0 μm can be used. Furthermore, separation and specification of graphite included in the carbonaceous molded body for a battery electrode can be performed based on the true density measured using the JIS density gradient tube method, similarly to non-graphitizable carbonaceous material or graphitizable carbonaceous material.

### Metal or Metal Compound Capable of Lithium Doping and Dedoping

Examples of the anode active material included in the carbonaceous molded body for a battery electrode of the present invention can include metals and metal compounds capable of lithium doping and dedoping. Examples of metals capable of lithium doping and dedoping can include metals that form alloys with lithium by lithium doping. Mg, Ca, Al, Si, Ge, Sn, Pb, As, Sb, Bi, Ag, Au, Cd, and Hg are known as metals that form alloys with lithium, where Pb, Sn, Ge, Al, and Si are preferred due having high capacity. Furthermore, examples of alloys capable of lithium doping and dedoping include lithium doping types, substitution types, and successive alloying types. A lithium doping type alloy is a material that is topotactically doped with lithium at empty sites in a host without change in the crystal structure of the original alloy (intermetallic compound) during lithium alloy formation.

xLi⁺+MM′+xe′ [symbol] LiₓMM′_{y} [Reaction Scheme 1]

Examples of alloys include Cu₆Sn₅, Mg₂Si, and the like. A substitution type alloy is a material that is doped with lithium based on one of the components of the alloy (intermetallic compound) alloying with lithium, and another component precipitating out by phase separation. Examples thereof include Sn₂Fe, NiₓSn, CoₓSn, NiSi, FeSi, MgₓNi, and the like. A successive alloying type alloy (intermetallic compound) is a material that is doped with lithium based on one component alloying first and then phase-separating and acting as a matrix, and then another component alloying. Examples thereof include SnSb, InSb, Ag—Sn—Sb, and the like. Examples of metal compounds capable of lithium doping and dedoping can include metal oxides, metal nitrides, and metal sulfides. Examples of the metal oxides can include Nb₂O₅, TiO₂, Li_{4/3}Ti_{5/3}O₄, WO₂, MoO₂, Fe₂O₃, SnO₂, SiO, and CoO. Furthermore, examples of metal nitrides can include Li₃N, LiFe₃N₂, and Li_{2.6}Co_{0.4}N. Furthermore, examples of metal sulfides can include Sn—Sb—S glass. Examples of metals or metal compounds capable of lithium doping and dedoping can include metal oxides where lithium enters an anode by reacting with oxygen and converting to Li₂O or the like, as with CoO, FeO, NiO, CuO, or the like, for example. Note that in the present specification, “lithium doping and dedoping” includes lithium conversion.

The anode active material preferably has a higher capability for lithium doping and dedoping and a higher proportion of dedoping capacity with regard to doping capacity during the initial doping and dedoping reaction (initial coulombic efficiency). Furthermore, a higher true density of the active material (the average true density of the plurality of active material particles when a plurality of active material particles are used) is preferred in order to improve volume energy density. A metal or metal compound capable of lithium doping and dedoping has a higher capacity than carbonaceous material or graphitic material. Note that expansion and contraction of the electrode as a whole can be suppressed by adding a substance not involved in alloying with lithium, and therefore, a substance that does not contribute to alloying with lithium may be added to an element that form alloys with lithium.

The amount of carbon fibers capable of lithium doping and dedoping in the carbonaceous molded body for a battery electrode of the present invention is not limited, but is preferably from 7 to 50 wt. %, more preferably from 8 to 40 wt. %, and even more preferably from 9 to 30 wt. %. When the amount is from 7 to 50 wt. %, the carbon fibers capable of lithium doping and dedoping can exhibit sufficient capacity as an anode material. Furthermore, the amount of anode active materials in the carbonaceous molded body for a battery electrode is not particularly limited, but is preferably from 50 to 93 wt. %, more preferably from 60 to 92 wt. %, and even more preferably from 70 to 91 wt. %.

Furthermore, the amount of anode active materials in the carbonaceous molded body for a battery electrode is not limited, but when non-graphitizable carbonaceous material is included as an essential component, the non-graphitizable carbonaceous material is preferably from 1 to 93 wt. %, graphitizable carbonaceous material is from 0 to 92 wt. %, graphite is from 0 to 92 wt. %, and metal or metal compounds capable of lithium doping and dedoping is from 0 to 92 wt. %. The amount of graphite is particularly preferably 60 wt. % or less. When the amount of graphite is too high, expansion and contraction may be large, the carbonaceous molded body for a battery electrode may be destroyed, doping and dedoping of lithium may be blocked, and repeating properties may become inferior. Furthermore, if a graphitizable carbonaceous material is included as an essential component, the graphitizable carbonaceous material is preferably from 1 to 93 wt. %, non-graphitizable carbonaceous material is from 0 to 92 wt. %, graphite is from 0 to 92 wt. %, and metal or metal compounds capable of lithium doping and dedoping is from 0 to 92 wt. %. The amount of graphite is particularly preferably 60 wt. % or less. When the amount of graphite is too high, expansion and contraction may be large, the carbonaceous molded body for a battery electrode may be destroyed, doping and dedoping of lithium may be blocked, and repeating properties may become inferior.

The carbonaceous molded body for a battery electrode of the present invention is not limited so long as use as an electrode is possible. An example of using the carbonaceous molded body for a battery electrode of the present invention as a battery electrode can include a non-aqueous electrolyte secondary battery. Examples of non-aqueous electrolyte secondary batteries include lithium-ion secondary batteries, sodium ion secondary batteries, and the like. The carbonaceous molded body for a battery electrode of the present invention can also be used as an electrode of an all-solid-state battery, and examples thereof include all-solid-state lithium-ion secondary batteries, all-solid-state sodium-ion secondary batteries, and the like. Furthermore, the molded body can be used as a bipolar electrode of a bipolar battery. Furthermore, the carbonaceous molded body for a battery electrode of the present invention can be used as an electrode of a redox flow battery.

### [2] Electrode for Battery

An electrode for a battery of the present invention includes the aforementioned carbonaceous molded body for a battery electrode. The carbonaceous molded body for a battery electrode of the present invention is not limited, but can be used as an electrode having no current collector (current collector plate).

However, when the carbonaceous molded body for a battery electrode of the present invention is bonded to the current collector, the molded body of the present invention can be used as an electrode, and can also be used as a current collector (current collector plate), usually without being limited to those used in electrodes for secondary batteries. Examples of current collectors (current collector plates) include copper and nickel. Furthermore, by using the carbonaceous material of the present invention, an anode having high conductivity can be manufactured without particularly adding a conductive agent. However, the electrode for a battery of the present invention may also include a conductive agent (for example, conductive carbon black, vapor grown carbon fibers (VGCF), or carbon nanotubes). A conductive agent is added in order to improve the conductivity of the electrode. In other words, a conductive agent is a conductive electron conductor, and is not used as an ion conductor in an anode. The aforementioned vapor grown carbon fibers are electron conducting carbon fibers. Vapor grown carbon fibers are not substantially doped and dedoped with lithium.

### [3] Non-Aqueous Electrolyte Secondary Battery

The non-aqueous electrolyte secondary battery of the present invention includes the aforementioned carbonaceous molded body for a battery electrode or electrode for a battery. The non-aqueous electrolyte secondary battery that includes the carbonaceous molded body for a battery electrode of the present invention is particularly excellent in charge/discharge capacity, non-dedoping capacity (irreversible capacity), and efficiency.

### Manufacturing Nonaqueous Electrolyte Secondary Battery

When an anode for a non-aqueous electrolyte secondary battery is formed from the carbonaceous molded body for a battery electrode of the present invention, the other materials configuring the battery such as a cathode material, separator, and electrolyte solution are not particularly limited, and various materials that have been conventionally used or proposed for non-aqueous solvent secondary batteries can be used.

For example, layered oxide-based (as represented by LiMO₂, where M is a metal such as LiCoO₂, LiNiO₂, LiMnO₂, or LiNiₓCo_{y}Mn_{z}O₂ (where x, y, and z represent composition ratios)), olivine-based (as represented by LiMPO₄, where M is a metal such as LiFePO₄ and the like), and spinel-based (as represented by LiM₂O₄, where M is a metal such as LiMn₂O₄ and the like) complex metal chalcogen compounds are preferable as cathode materials, and chalcogen compounds may be mixed if necessary. A cathode is formed by molding the cathode materials with an appropriate binder and a carbon material for imparting conductivity to the electrode and to form a layer on a conductive current collector.

A non-aqueous electrolyte solution used with this cathode and anode combination is typically formed by dissolving an electrolyte in a non-aqueous solvent. One type or two or more types of organic solvents such as propylene carbonate, ethylene carbonate, dimethyl carbonate, diethyl carbonate, dimethoxyethane, diethoxyethane, γ-butyl lactone, tetrahydrofuran, 2-methyl tetrahydrofuran, sulfolane, 1,3-dioxolane, or the like may be used in combination as a non-aqueous solvent. Furthermore, LiClO₄, LiPF₆, LiBF₄, LiCF₃SO₃, LiAsF₆, LiCl, LiBr, LiB(C₆H₅)₄, LiN(SO₃CF₃)₂ or the like can be used as an electrolyte.

### Electrolyte Additive

The non-aqueous electrolyte secondary battery of the present invention preferably contains an additive having a LUMO value within a range of −1.10 to 1.11 eV in the electrolyte, which is calculated using an Austin Model 1 (AM 1) calculation method of a semiemperical molecular orbital model. The non-aqueous electrolyte secondary battery using an anode of a non-aqueous electrolyte secondary battery that uses a carbonaceous material and an additive according to the present invention has high doping and dedoping capacity and demonstrates excellent high-temperature cycle characteristics.

A secondary battery is typically formed by mutually facing an anode electrode layer formed as described above through a liquid permeable separator formed from a nonwoven fabric, other porous material, and the like if necessary, and then immersing a cathode layer in an electrolyte solution. As a separator, a liquid permeable separator formed from a nonwoven fabric and other porous material that are typically used in secondary batteries can be used. Alternatively, a solid electrolyte formed from polymer gel into which an electrolyte solution is impregnated can be also used in place of a separator or together with a separator.

### [4] Method of Manufacturing Carbonaceous Molded Body for Battery Electrode

A method of manufacturing a carbonaceous molded body for a battery electrode of the present invention includes the steps of: (1) mixing carbon fibers and or a carbon fiber precursor thereof where lithium can be doped and dedoped, and a carbonaceous precursor to obtain a mixture; (2) molding the mixture to obtain a molded body; and (3) firing in order to heat treat the molded body under a non-oxidizing gas atmosphere at 1000° C. to 2000° C. The carbonaceous material precursor is preferably a non-graphitizable carbonaceous material precursor and/or graphitizable carbonaceous material precursor. The fired carbonaceous molded body for a battery electrode preferably contains carbon fibers where 7 wt. % or greater of lithium can be doped and dedoped, and/or a carbon fiber precursor thereof. A carbonaceous molded body for a battery electrode where carbonaceous material and carbon fibers where lithium can be doped and dedoped and/or a carbon fiber precursor thereof can be obtained by volatile matter content included in the carbonaceous precursor.

Furthermore, the manufacturing method of the present invention does not include an anode active material coating step performed in conventional anode manufacturing, and therefore, a manufacturing process can be simplified.

In the method of manufacturing a carbonaceous molded body for a battery electrode of the present invention, one or more anode active materials selected from the group consisting of metals capable of lithium doping and dedoping and metal compounds capable of lithium doping and dedoping may be mixed in the aforementioned mixing step (1). In other words, a method of manufacturing a carbonaceous molded body for a battery electrode of the present invention includes the steps of: (1) mixing carbon fibers and or a carbon fiber precursor thereof where lithium can be doped and dedoped, and a carbonaceous precursor to obtain a mixture; (2) molding the mixture to obtain a molded body; and (3) firing in order to heat treat the molded body under a non-oxidizing gas atmosphere at 1000° C. to 2000° C.;

In the aforementioned mixing step (1) of the method of manufacturing the carbonaceous molded body for a battery electrode of the present invention, one or more anode active materials or the like selected from the group consisting of non-graphitizable carbonaceous materials, graphitizable carbonaceous materials, and graphite may be further mixed.

Furthermore, in the method of manufacturing the carbonaceous molded body for a battery electrode of the present invention, the molded body in the molding step (2) may be obtained by compression molding.

### Non-Graphitizable Carbonaceous Material and Non-Graphitizable Carbonaceous Material Precursor

The non-graphitizable carbonaceous materials that can be used in the manufacturing method of the present invention are not limited, but materials having the same physical properties as the non-graphitizable carbonaceous material described in the aforementioned section “Carbonaceous Molded Body for Battery Electrode” may be used, and materials that have the same physical properties as the aforementioned non-graphitizable carbonaceous materials by undergoing firing may be used. A non-graphitizable carbonaceous material precursor can be used independently or a mixture of a non-graphitizable carbonaceous material and a non-graphitizable carbonaceous material precursor can be used to obtain the non-graphitizable carbonaceous material included in the carbonaceous molded body for a battery electrode in the manufacturing method of the present invention. This is because non-graphitizable carbonaceous material precursors often include volatile matter content and can bond the non-graphitizable carbonaceous material and the carbonaceous material precursor to the carbon fibers capable of lithium doping and dedoping and/or carbon fiber precursor thereof during molding prior to firing. Furthermore, the non-graphitizable carbonaceous material precursor preferably exhibits the same physical properties as the non-graphitizable carbonaceous material described in the aforementioned section “Carbonaceous Molded Body for Battery Electrode” by undergoing the firing step of this manufacturing method (firing at 1000° C. to 2000° C.). Furthermore, the non-graphitizable carbonaceous material or non-graphitizable carbonaceous material precursor is preferably in a particulate form. However, a liquid non-graphitizable carbonaceous material precursor can also be used.

Graphitizable Carbonaceous Material and Graphitizable Carbonaceous Material Precursor

The graphitizable carbonaceous materials that can be used in the manufacturing method of the present invention are not limited, but materials having the same physical properties as the graphitizable carbonaceous material described in the aforementioned section “Carbonaceous Molded Body for Battery Electrode” may be used, and materials that have the same physical properties as the aforementioned graphitizable carbonaceous materials by undergoing firing may be used. A graphitizable carbonaceous material precursor can be used independently or a mixture of a graphitizable carbonaceous material and a graphitizable carbonaceous material precursor can be used to obtain the graphitizable carbonaceous material included in the carbonaceous molded body for a battery electrode in the manufacturing method of the present invention. This is because graphitizable carbonaceous material precursors often include volatile matter content and can bond the carbonaceous material and the carbonaceous material precursor to the carbon fibers capable of lithium doping and dedoping and/or carbon fiber precursor thereof during molding prior to firing. The graphitizable carbonaceous material precursor preferably exhibits the same physical properties as the graphitizable carbonaceous material described in the aforementioned section “Carbonaceous Molded Body for Battery Electrode” by undergoing the firing step of this manufacturing method (firing at 1000° C. to 2000° C.). Note that the graphitizable carbonaceous material or graphitizable carbonaceous material precursor is preferably in a particulate form. However, a liquid graphitizable carbonaceous material precursor can also be used.

### Graphite

The graphite that can be used in the manufacturing method of the present invention is not limited, but the graphite described in the aforementioned section “Carbonaceous Molded Body for Battery Electrode” can be used.

Note that in this specification, “anode active material” refers to a non-graphitizable carbonaceous material, graphitizable carbonaceous material, graphite, or a metal or metal compound capable of lithium doping and dedoping, while “anode active material precursor” and “turbostratic structure carbonaceous material precursor” refers to a non-graphitizable carbonaceous material precursor or graphitizable carbonaceous material precursor.

### Metal or Metal Compound Capable of Lithium Doping and Dedoping

The metal or metal compound capable of lithium doping and dedoping that can be used in the manufacturing method of the present invention is not limited, but the metal or metal compound capable of lithium doping and dedoping described in the aforementioned section “Carbonaceous Molded Body for Battery Electrode” can be used.

In the manufacturing method of the present invention, the carbonaceous material precursor and metal or metal compound capable of lithium doping and dedoping may be used as essential components, and a mixture of carbonaceous material and/or graphite may be used. This is because carbonaceous material precursors often include volatile matter content and can bond the anode active material to the carbon fibers capable of lithium doping and dedoping and/or carbon fiber precursor thereof during molding prior to firing. Furthermore, the carbonaceous material precursor exhibits the same physical properties as the turbostratic structure carbonaceous material described in the aforementioned section “Carbonaceous Molded Body for Battery Electrode” by undergoing the firing step of this manufacturing method.

### Carbon Fibers Capable of Lithium Doping and Dedoping

The carbon fibers capable of lithium doping and dedoping that can be used in the present invention is not limited, but carbon fibers capable of lithium doping and dedoping described in the aforementioned section “Carbonaceous Molded Body for Battery Electrode” can be used. In other words, a carbon structure with reduced expansion and contraction due to doping/dedoping of lithium is preferably provided. The carbon fibers having the structure is not limited, but the true density is preferably from 1.4 to 1.8 g/cm³, and more preferably from 1.4 to 1.7 g/cm³. The average fiber length of the carbon fibers is not limited, but is preferably from 0.01 to 30 mm, more preferably from 0.09 to 25 mm, and even more preferably from 0.1 to 5 mm. Furthermore, the average fiber diameter of the carbon fibers is preferably from 0.5 to 30 μm, and more preferably from 1 to 20 μm.

Specifically, examples of the carbon fibers capable of lithium doping and dedoping can include polyacrylonitrile-based carbon fibers, pitch-based carbon fibers, and rayon-based carbon fibers, but the pitch-based carbon fibers are preferable. Furthermore, examples of the pitch-based carbon fibers can include pitch-based carbon fibers having an isotropic structure and pitch-based carbon fibers having an anisotropic structure, but pitch-based carbon fibers having an isotropic structure are preferred.

### Precursor of Carbon Fibers Capable of Lithium Doping and Dedoping

A precursor of carbon fibers capable of lithium doping and dedoping that can be used in the present invention is not limited so long as the carbon fibers are capable of lithium doping and dedoping by firing. However, carbon fibers having a carbon structure with reduced expansion and contraction due to lithium doping/dedoping are preferably obtained. The true density of the carbon fiber precursor where carbon fibers with this structure are obtained is not limited, but is preferably from 1.4 to 1.8 g/cm³ and more preferably from 1.4 to 1.7 g/cm³. The average fiber length of the carbon fiber precursor is not limited, but is preferably from 0.01 to 30 mm, more preferably from 0.09 to 25 mm, and even more preferably from 0.1 to 5 mm. The average fiber diameter of the carbon fibers is preferably from 0.5 to 30 μm, and more preferably from 1 to 20 μm. The true density of the carbon fibers is not limited, but is preferably from 1.4 to 1.8 g/cm³ and more preferably from 1.4 to 1.7 g/cm³.

Specifically, examples of the carbon fiber precursor capable of lithium doping and dedoping can include polyacrylonitrile-based carbon fiber precursors, pitch-based carbon fiber precursors, and rayon-based carbon fiber precursors, but the pitch-based carbon fiber precursors are preferable. Furthermore, pitch-based carbon fiber precursors having an isotropic structure or pitch-based carbon fiber precursors having an anisotropic structure can be used as the pitch-based carbon fiber precursors, but pitch-based carbon fiber precursors having an isotropic structure are preferred.

### (1) Mixing Step

In the mixing step (1), a carbonaceous precursor and carbon fibers capable or lithium doping and dedoping and/or a carbon fiber precursor thereof are mixed. For mixing, a mixing method that is typically used in the field can be used without limitation. For example, a carbonaceous precursor and carbon fiber capable of lithium doping and dedoping can be mixed using a ribbon mixer, V-type mixer, W-type mixer, or drum mixer as a mixing device.

The anode active material precursor used in the mixing step is preferably in a particulate form. However, a liquid anode active material precursor may be used. A mixture of a liquid and a particulate form may be used for the anode active material precursor.

### (2) Molding Step

The molding step in the manufacturing method of the present invention is a step of molding the mixture obtained in the mixing step to obtain a molded body. Molding can be performed by compression molding where surface pressure is applied on the obtained mixture. Specifically, compression molding can be performed as follows.

The mixture prepared in the aforementioned step can be molded by inserting in a mold, pressurizing, and then returning to ambient pressure for example. Furthermore, the mixture can be inserted in a heat pressing device and then molding while heating in a non-oxidizing gas atmosphere. The non-oxidizing gas is not particularly limited, but examples thereof can include helium, nitrogen, argon, and the like, and these gases may be used independently or as a mixture.

### (3) Firing Step

The firing step in the manufacturing method of the present invention is a step of firing the molded body at 1000° C. to 2000° C. in a non-oxidizing gas atmosphere. Firing is preferably performed in a non-oxidizing gas atmosphere. In the technical field of the present invention, firing at 1000° C. to 2000° C. is typically called “final firing”. Furthermore, in the firing step of the present invention, pre-firing can be performed prior to final firing if necessary.

Firing in the manufacturing method of the present invention can be performed in accordance with a typical procedure, and firing can be performed to obtain a carbonaceous molded body for a battery electrode. The firing temperature is 1000 to 2000° C. If the firing temperature is lower than 1000° C., a large amount of functional groups remain in the carbonaceous molded body for a battery electrode, the value of H/C increases, and the irreversible capacity increases due to a reaction with lithium, which is not preferable. A lower limit of the firing temperature in the present invention is 1000° C. or higher, more preferably 1100° C. or higher, and particularly preferably 1150° C. or higher. On the other hand, if the firing temperature exceeds 2000° C., the selective orientation of the carbon hexagonal plane increases and the discharge capacity decreases, which is not preferable. An upper limit of the firing temperature in the present invention is 2000° C. or lower, more preferably lower than 2000° C., even more preferably 1800° C. or lower, yet even more preferably 1600° C. or lower, and most preferably 1500° C. or lower. Note that if the carbonaceous molded body for a battery electrode includes a metal anode material, a slightly lower firing temperature is preferable, as compared to a carbonaceous molded body for a battery electrode that does not include a metal material.

The carbonaceous precursor is carbonized and reduced in weight by the firing step (3). On the other hand, the carbon fibers capable or lithium doping and dedoping are fired and carbonized, and thus weight reduction due to firing is low. Therefore, in order to achieve an amount of 7 wt. % or greater for carbon fibers capable of lithium doping and dedoping included in the obtained carbonaceous molded body for a battery electrode for example, the amount of carbon fibers capable of lithium doping and dedoping in the mixing step (1) is preferably less than 7 wt. %, and then the amount of carbon fibers capable of lithium doping and dedoping in the obtained carbonaceous molded body for a battery electrode is preferably adjusted. Note that if a precursor of carbon fibers capable of lithium doping and dedoping is used, the weight of the carbon fiber precursor is also reduced, and therefore, the amount of the carbon fiber precursor is preferably adjusted accordingly.

The amount of carbon fibers capable of lithium doping and dedoping in the mixture prior to firing is not limited, but is preferably from 5 to 50 wt. %, more preferably from 6 to 40 wt. %, and even more preferably from 7 to 30 wt. %. Furthermore, the amount of anode active material precursors or the like in the mixture prior to firing is not limited, but is preferably from 50 to 95 wt. %, more preferably from 60 to 94 wt. %, and even more preferably from 70 to 93 wt. %.

Furthermore, the amount of anode active materials mixture prior to firing is not limited, but if a non-graphitizable carbon precursor is included as an essential component, the non-graphitizable carbon precursor is preferably from 1 to 95 wt. %, graphitizable carbon precursor is from 0 to 94 wt. %, graphite is from 0 to 94 wt. %, and metal or metal compounds capable of lithium doping and dedoping is from 0 to 94 wt. %. In particular, the amount of graphite is preferably 60 wt. % or less, and more preferably 55 wt. % or less. When the amount of graphite is too high, expansion and contraction may be large, the carbonaceous molded body for a battery electrode may be destroyed, doping and dedoping of lithium may be blocked, and repeating properties may become inferior.

Furthermore, if a graphitizable carbonaceous material is included as an essential component, a graphitizable carbon is preferably from 1 to 95 wt. %, non-graphitizable carbonaceous material is from 0 to 94 wt. %, graphite is from 0 to 94 wt. %, and metal or metal compounds capable of lithium doping and dedoping is from 0 to 94 wt. %. In particular, the amount of graphite is preferably 60 wt. % or less, and more preferably 55 wt. % or less. When the amount of graphite is too high, expansion and contraction may be large, the carbonaceous molded body for a battery electrode may be destroyed, doping and dedoping of lithium may be blocked, and repeating properties may become inferior.

Furthermore, if a metal anode material is essentially included, turbostratic structure carbon is from 1 to 95 wt. %, graphite is from 0 to 94 wt. %, and a metal or metal compound capable of doping and dedoping lithium is from 1 to 94 wt. %. In particular, the amount of graphite is preferably 60 wt. % or less, and more preferably 55 wt. % or less. When the amount of graphite is too high, expansion and contraction may be large, the carbonaceous molded body for a battery electrode may be destroyed, doping and dedoping of lithium may be blocked, and repeating properties may become inferior.

Firing is preferably performed in a non-oxidizing gas atmosphere. Examples of a non-oxidizing gas include helium, nitrogen, argon, and the like, which can be used independently or as a mixture. Furthermore, firing can also be performed in a gas atmosphere in which a halogen gas such as chlorine or the like is mixed with the non-oxidizing gas described above. The supplied amount (circulated amount) of gas is not limited, but is 1 mL/min or greater, preferably 5 mL/min or greater, and even more preferably 10 mL/min or greater, per 1 g of the molded body. Furthermore, firing can be performed under reduced pressure at a pressure of 10 kPa or lower for example. The firing time is not particularly limited, but can be performed for 0.05 to 10 hours, preferably 0.05 to 3 hours, and more preferably 0.05 to 1 hour, as the residence time at 1000° C. or higher, for example.

### EXAMPLES

The present invention will be described in detail below using examples, but the examples do not limit the scope of the present invention.

Methods of measuring physical property values (“thickness of carbonaceous molded body for a battery electrode,” “bulk density,” “specific surface area,” “hydrogen/carbon atomic ratio (H/C),” “true density by pycnometer method using butanol,” “true density by density gradient tube method,” “porosity,” “volatile matter content,” “measurement of combustion temperature by differential thermal analysis,” “average interlayer separation d₀₀₂ by X-ray diffraction,” “L_{C(002)} by X-ray diffraction,” “average particle size by laser diffraction,” and “pore volume by mercury intrusion”) of the carbonaceous molded body for a battery electrode of the present invention are described below, but the physical property values described in the present specification including the examples are based on values determined by the following methods.

### Thickness of Carbonaceous Molded Body for Battery Electrode

The thickness of the carbonaceous molded body for a battery electrode was measured using a “thickness gauge ID-C112X, 7002-10” manufactured by Mitutoyo Corporation.

### Bulk Density of Carbonaceous Molded Body for Battery Electrode

The bulk density of the carbonaceous molded body for a battery electrode was calculated by dividing the mass of the carbonaceous molded body for a battery electrode by the volume (area×thickness) determined from the exterior dimensions of the carbonaceous molded body for a battery electrode.

The mass of the carbonaceous molded body for a battery electrode was measured using an “analytical electronic balance XS105DUV” manufactured by Mettler-Toledo International Inc. The area of the carbonaceous molded body for a battery electrode was calculated by punching the carbonaceous molded body into a disc shape with a diameter of 15 mm. Furthermore, if the carbonaceous molded body cannot be punched into a disc shape, the exterior dimensions were measured using “calipers CD-20” manufactured by Mitutoyo Corporation, and then volume was calculated. The bulk density ρ_{B} of the carbonaceous molded body for a battery electrode was calculated by dividing the aforementioned weight by the volume.

### Specific Surface Area

The specific surface area (SSA) was measured in accordance with a method stipulated in JIS Z8830. A summary is given below. A value vₘ was determined by a one-point method (relative pressure x=0.2) based on nitrogen adsorption at the temperature of liquid nitrogen using approximation vₘ=1/(v (1−x)) derived from the BET equation, and the specific surface area of the sample was calculated from the following equation:

$$Specific surface area ( SSA ) = 4.35 \times {v}_{m} ( {m}^{2} \text{/} g ) . \qquad [ Equation 2 ]$$

(Where vₘ is the amount of adsorption (cm³/g) required to form a monomolecular layer on a sample surface; v is the amount of adsorption (cm³/g) actually measured; and x is the relative pressure).

Specifically, the amount of adsorption of nitrogen in the carbonaceous material at the temperature of liquid nitrogen was measured as follows using a “Flow Sorb II 2300” manufactured by Micromeritics Instrument Corporation. A test tube was filled with a sample cut to approximately 2 mm×2 mm, and the test tube was cooled to −196° C. while infusing helium gas containing nitrogen gas at a concentration of 20 mol % such that the nitrogen was absorbed into the carbonaceous material. The test tube was then returned to room temperature. The amount of nitrogen desorbed from the sample at this time was measured with a thermal conductivity detector and used as the adsorption gas amount v.

### Atomic Ratio (H/C) of Hydrogen/Carbon

The atomic ratio was measured in accordance with a method stipulated in JIS M8819. In other words, each of the weight proportions of hydrogen and carbon in a sample obtained by elemental analysis using a CHN analyzer (2400II manufactured by Perkin Elmer Inc.) was divided by the mass number of each element to determine the ratio of the numbers of hydrogen/carbon atoms.

### True Density by Pycnometer Method Using Butanol

Measurements were performed using butanol in accordance with a method stipulated in JIS R7212. A summary is given below. The mass (m₁) of a pycnometer with a bypass line having an internal volume of approximately 40 mL was precisely measured. Next, after a sample cut to approximately 2 mm×2 mm was placed flat at the bottom of the pycnometer so as to have a thickness of approximately 10 mm, the mass (m₂) was precisely measured. 1-butanol was slowly added to the pycnometer to a depth of approximately 20 mm from the bottom. Next, the pycnometer was gently oscillated, and after confirming that no large air bubbles were formed, the pycnometer was placed in a vacuum desiccator and gradually evacuated to a pressure of 2.0 to 2.7 kPa. The pressure was maintained for 20 minutes or longer, and after the generation of air bubbles stopped, the bottle was removed and further filled with 1-butanol. After inserting a stopper, the pycnometer was immersed in a constant-temperature bath (adjusted to 30±0.03° C.) for at least 15 minutes, and the liquid surface of 1-butanol was aligned with the marked line. Next, the pycnometer was removed, and after the outside of the pycnometer was thoroughly wiped and the pycnometer was cooled to room temperature, the mass (m₄) was precisely measured. Next, the same pycnometer was filled with 1-butanol and immersed in a constant-temperature water bath in the same manner as described above. After the marked line was aligned, the mass (m₃) was measured. Furthermore, distilled water which was boiled immediately before use and where the dissolved gas was removed was placed in the pycnometer and immersed in a constant-temperature water bath in the same manner as described above. After the marked line was aligned, the mass (m₅) was measured. The true density (ρ_{T}) is calculated using the following equation. This was used as ρ_{T}.

$${ρ}_{B} = \frac{{m}_{2} - {m}_{1}}{{m}_{2} - {m}_{1} - ( {m}_{4} - {m}_{3} )} \times \frac{{m}_{3} - {m}_{1}}{{m}_{5} - {m}_{1}} d \qquad [ Equation 3 ]$$

(Herein, d is the specific gravity (0.9946) at 30° C. in water.)

Note that the true density of carbon fibers can also be measured by this method.

### True Density by Density Gradient Tube Method

True density was measured in accordance with a density gradient tube method of a carbon fiber density test method (JIS R7603-1999). With this method, the non-graphitizable carbonaceous material, graphitizable carbonaceous material, and graphite included in the carbonaceous molded bodies for a battery electrode obtained in Examples 1 to 4 can be separated and identified.

### Porosity of Carbonaceous Molded Body for Battery Electrode

The porosity ε of the carbonaceous molded body for a battery electrode was determined by the following equation from the aforementioned bulk density ρ_{B} and the true density ρ_{T} determined by the pycnometer method using butanol. Furthermore, when the molded body is configured of a mixture of substances having different true densities, the weighted average value of true density of the substances that configure the molded body may be used as the true density of the molded body.

$$ɛ = ( 1 - \frac{{ρ}_{B}}{{ρ}_{T}} ) \times 100 \qquad [ Equation 4 ]$$

### Volatile Matter Content

Approximately 1 g of a sample was collected in a dried crucible, and after drying for 30 min at 105° C. in a non-oxidizing gas atmosphere, the sample was cooled to room temperature in a dry desiccator, and the dry mass of the sample in the crucible was measured. Then, the crucible was placed in an electric furnace, and heated in the electric furnace to 800° C. at a heating rate of 10° C./min while nitrogen flowed at a rate of 20 liters/min, and then forcibly heated at 800° C. for 1 hour. The crucible was cooled to room temperature in a nitrogen atmosphere and the volatile matter content was removed. The mass of the sample was then measured, and the volatile matter content was calculated using the following equation.

$$VM = \frac{{W}_{2} - {W}_{3}}{{W}_{2} - {W}_{1}} \times 100 \qquad [ Equation 5 ]$$

Mass of crucible: W₁
Mass of crucible and sample after drying: W₂
Mass of crucible and sample after ignition: W₃
Volatile matter content: VM

### Measurement of Combustion Temperature by Differential Thermal Analysis

The combustion temperature can be measured by differential thermal analysis in the following manner.

Differential thermal analysis is performed under a dry air flow using a DTG-50 manufactured by Shimadzu Corporation. Analysis conditions include a 2 mg sample, 100 mL/min air flow, and 10° C./min heating rate. The exothermic peak temperature can be read from a differential thermal curve.

The combustion temperature of the sample was determined from the obtained exothermic peak temperature.

Average Interlayer Spacing (d002) by X-Ray Diffraction

A sample holder is filled with a carbon material powder, and an X-ray diffraction pattern is obtained using CuKα rays monochromatized by a Ni filter as a radiation source. The peak position of the diffraction pattern is determined by a method of elastic center (method of determining a position of the center of gravity of diffraction lines and determining the peak position with a corresponding value of 2θ), which is corrected using a diffraction peak of the (111) plane of a high-purity silicone powder used as a reference substance. The wavelength of the CuKα rays is set to 0.15418 nm, and d₀₀₂ is calculated by Bragg's equation.

$${d}_{002} = \frac{λ}{2 \cdot sin θ} \qquad [ Equation 6 ]$$

### Calculation of L_{c(002)} by X-Ray Diffraction

L_{c(002)} is calculated by substituting into the Scherrer equation.

$${L}_{C ( 002 )} = \frac{K \cdot λ}{β \cdot cos θ} \qquad [ Equation 7 ]$$

K: Form factor (0.9)
λ: X-ray wavelength (CuK_{αm}=0.15418 nm)
θ: Diffraction angle
β: Half width value of 002 diffraction peak (2θ corresponding to position where peak spread is at half-intensity)

### Average Particle Size Based on Laser Diffraction

Three drops of a dispersant (cationic surfactant, “SN-WET 366” (manufactured by San Nopco Limited)) were added to approximately 0.01 g of a sample, and then the dispersant was blended into the sample. Next, 30 mL of pure water was added, and after dispersing for approximately 2 minutes with an ultrasonic washer, the particle size distribution within a particle size range of 0.5 to 3000 μm was determined with a particle size distribution measurer (“SALD-3000S” manufactured by Shimadzu Corporation). The refractive index of the particles was 2.0 to 0.1 i. The average particle size Dv₅₀ (μm) was determined from the obtained particle size distribution as a particle size yielding a cumulative volume of 50%.

### Manufacturing Example 1

In the present manufacturing example, a non-graphitizable carbonaceous material precursor was manufactured.

First, 70 kg of a petroleum-based pitch with a softening point of 205° C. and an H/C atomic ratio of 0.65, and 30 kg of naphthalene were charged into a pressure-resistant container with an internal volume of 300 liters and having a stirring blade and an outlet nozzle, and after the substances were melted and mixed while heating at 190° C., the mixture was cooled to 80 to 90° C. The inside of the pressure-resistant container was pressurized by nitrogen gas, and the contents were extruded from the outlet nozzle to obtain a string-shaped molded body with a diameter of approximately 500 μm. Next, the string-shaped molded body was pulverized such that the ratio (L/D) between the diameter (D) and the length (L) was approximately 1.5, and the obtained fractured product was added to an aqueous solution in which 0.53 wt. % of polyvinyl alcohol (degree of saponification: 88%) heated to 93° C. was dissolved, dispersed while stirring, and cooled to obtain a spherical pitch molded body slurry. After a large portion of the water was removed by filtration, the naphthalene in the pitch molded body was extracted with n-hexane at a quantity of 6 times the weight of the spherical pitch molded body. Using a fluidized bed, the porous spherical pitch obtained in this manner was heated to 270° C. and then oxidized by maintaining for one hour at 270° C. while hot air was passed over, and thus a heat-infusible porous spherical oxidized pitch was obtained. The pitch was pulverized to obtain a carbon precursor A.

### Manufacturing Example 2

In the present manufacturing example, a graphitizable carbonaceous material precursor was manufactured.

First, 68 kg of a petroleum-based pitch having a softening point of 210° C., a quinoline insoluble content of 1 wt. %, and an H/C atomic ratio of 0.63%, and 32 kg of naphthalene were charged into a pressure-resistant vessel with an internal volume of 300 liters and having a stirring blade. After the substances were dissolved and mixed while heating at 190° C., the mixture was cooled to 80 to 90° C. and extruded to obtain a string-like molded body with a diameter of approximately 500 μm. Next, the string-shaped molded body was pulverized such that the ratio between the diameter and the length was approximately 1.5, and the obtained pulverized material was dropped in a 0.53% polyvinyl alcohol aqueous solution (degree of saponification: 88%) heated to 93° C., dispersed while stirring, and then cooled to obtain a spherical pitch molded body. After a large portion of the water was removed by filtration, the naphthalene in the pitch molded body was extracted with n-hexane at a quantity of 6 times the weight of the spherical pitch molded body. The spherical pitch porous body obtained thereby was subjected to an oxidation treatment while passing the sample through heated air and maintaining the body at 165° C. for 1 hour to obtain a porous spherical oxidized pitch. The pitch was pulverized to prepare a carbon precursor B.

### Manufacturing Example 3

The carbon precursor B obtained in the aforementioned Manufacturing Example 2 was heat treated for 1 hour at 480° C. in a nitrogen atmosphere to obtain a carbon precursor C. The carbon precursor was pulverized to form carbon precursor fine particles having an average particle size of approximately 12 μm.

### Manufacturing Example 4

First, 70 kg of a petroleum-based pitch with a softening point of 205° C. and an H/C atomic ratio of 0.65, and 30 kg of naphthalene were charged into a pressure-resistant container with an internal volume of 300 liters and having a stirring blade and an outlet nozzle, and after the substances were melted and mixed while heating at 190° C., the mixture was cooled to 80 to 90° C. The inside of the pressure-resistant container was pressurized by nitrogen gas, and the contents were extruded from the outlet nozzle to obtain a string-shaped molded body with a diameter of approximately 500 μm. Next, the string-shaped molded body was pulverized such that the ratio (L/D) between the diameter (D) and the length (L) was approximately 1.5, and the obtained fractured product was added to an aqueous solution in which 0.53 wt. % of polyvinyl alcohol (degree of saponification: 88%) heated to 93° C. was dissolved, dispersed while stirring, and cooled to obtain a spherical pitch molded body slurry. After a large portion of the water was removed by filtration, the naphthalene in the pitch molded body was extracted with n-hexane at a quantity of 6 times the weight of the spherical pitch molded body. Using a fluidized bed, the porous spherical pitch obtained in this manner was heated to 213° C. and then oxidized by maintaining for two hours at 213° C. while hot air was passed, and thus a heat-infusible porous spherical oxidized pitch was obtained.

### Example 1

In the present example, a carbonaceous molded body for a battery electrode was manufactured using the carbon precursor D obtained in Manufacturing Example 4 as an anode active material.

3 g of KRECA Milled (M-102S manufactured by Kureha Corporation) and 17 g of the carbon precursor D were mixed to obtain a mixed powder. The mixing weight ratio at this time was 85 wt. % of carbon precursor A and 15 wt. % of KRECA Milled. The mixed powder uniformly inserted in a 5 cm×5 cm mold. The powder was pressure molded at 15 MPa by a pressing device to obtain a molded body of the carbon precursor. The obtained molded body was heat treated for one hour at 1200° C. under a nitrogen atmosphere to obtain a carbonaceous molded body 1. Table 1 shows the composition of the carbon precursor and carbon molded body, and Table 2 shows the physical properties and battery performance of the carbonaceous molded body for a battery electrode.

### Example 2

In the present example, a carbonaceous molded body for a battery electrode was manufactured using the carbon precursor A as an anode active material.

The operation of Example 1 was repeated to obtain a carbonaceous molded body 2, except that the carbon precursor A was used in place of the carbon precursor D. Table 1 shows the composition of the carbon precursor and carbon molded body, and Table 2 shows the physical properties and battery performance of the carbonaceous molded body for a battery electrode.

### Example 3

In the present example, a carbonaceous molded body for a battery electrode was manufactured using the carbon precursor C and carbon precursor D as anode active materials.

The operation of Example 1 was repeated to obtain a carbonaceous molded body 3, except that the 60 wt. % of the carbon precursor C, 20 wt. % of the carbon precursor D, and 20 wt. % of KRECA Milled were used. Table 1 shows the composition of the carbon precursor and carbon molded body, and Table 2 shows the physical properties and battery performance of the carbonaceous molded body for a battery electrode.

### Example 4

In the present example, a carbonaceous molded body for a battery electrode was manufactured using the carbon precursor C as an anode active material.

The operation of Example 1 was repeated to obtain a carbonaceous molded body 4, except that the carbon precursor C was used. Table 1 shows the composition of the carbon precursor and carbon molded body, and Table 2 shows the physical properties and battery performance of the carbonaceous molded body for a battery electrode.

### Example 5

In the present example, a carbonaceous molded body for a battery electrode was manufactured using graphite and the carbon precursor C as anode active materials. The operation of Example 1 was repeated to obtain a carbonaceous molded body 5, except that 26 wt. % of graphite and 59 wt. % of the carbon precursor C were used. Table 1 shows the composition of the carbon precursor and carbon molded body, and Table 2 shows the physical properties and battery performance of the carbonaceous molded body for a battery electrode.

### Example 6

In the present example, a carbonaceous molded body for a battery electrode was manufactured using the carbon precursor C and Si as anode active materials.

The operation of Example 1 was repeated to obtain a carbonaceous molded body 6, except that 79 wt. % of the carbon precursor C and 6 wt. % of Si were used. Table 1 shows the composition of the carbon precursor and carbon molded body, and Table 2 shows the physical properties and battery performance of the carbonaceous molded body for a battery electrode.

### Example 7

In the present example, a carbonaceous molded body for a battery electrode was manufactured using the carbon precursor C and SnO₂ as anode active materials.

The operation of Example 1 was repeated to obtain a carbonaceous molded body 7, except that 79 wt. % of the carbon precursor C and 6 wt. % of SnO₂ were used. Table 1 shows the composition of the carbon precursor and carbon molded body, and Table 2 shows the physical properties and battery performance of the carbonaceous molded body for a battery electrode.

### Comparative Example 1

In the present comparative example, a carbonaceous molded body for a non-aqueous electrolyte secondary battery electrode was manufactured using furan resin carbon as an anode active material.

Furan resin (Hitafuran VF-303) was poured into an aluminum cup and cured by heating for one day at 70° C. and for one more day at 170° C., under reduced pressure. The obtained sheet-like furan resin was heat treated for 1 hour at 1200° C. in a nitrogen atmosphere. Table 2 shows various physical properties and the battery performance of the obtained active material molded body.

### Comparative Example 2

NMP was added to 75 parts by mass of Si (metal capable of lithium doping and dedoping), 20 parts by mass of polyvinylidene fluoride, and 5 parts by mass of conductive agent Super-P to make a paste, and this was applied uniformly onto copper foil. After drying, the sample was punched from the copper foil into a disc shape with a diameter of 15 mm, and then pressed to obtain an electrode. Note that the amount of Si (metal capable of lithium doping and dedoping) in the electrode was adjusted to approximately 3 mg. Table 2 shows the battery performance.

TABLE 1

| | Precursor composition (wt. %) | | | | | | |
|---|---|---|---|---|---|---|---|
| | | Precursor | Precursor | Precursor | | | |
| | Graphite | C | D | A | M-102S | Si | SnO₂ |
| Example 1 | 0 | 0 | 85 | 0 | 15 | 0 | 0 |
| Example 2 | 0 | 0 | 0 | 85 | 15 | 0 | 0 |
| Example 3 | 0 | 60 | 20 | 0 | 20 | 0 | 0 |
| Example 4 | 0 | 85 | 0 | 0 | 15 | 0 | 0 |
| Example 5 | 26 | 59 | 0 | 0 | 15 | 0 | 0 |
| Example 6 | 0 | 79 | 0 | 0 | 15 | 6 | 0 |
| Example 7 | 0 | 79 | 0 | 0 | 15 | 0 | 6 |
| | Molded carbon composition (wt. %) | | | | | | |
| | | Carbon | Carbon | Carbon | | | |
| | Graphite | C | D | A | M-102S | Si | SnO₂ |
| Example 1 | 0 | 0 | 82 | 0 | 18 | 0 | 0 |
| Example 2 | 0 | 0 | 0 | 80 | 20 | 0 | 0 |
| Example 3 | 0 | 59 | 18 | 0 | 23 | 0 | 0 |
| Example 4 | 0 | 83 | 0 | 0 | 17 | 0 | 0 |
| Example 5 | 28 | 55 | 0 | 0 | 16 | 0 | 0 |
| Example 6 | 0 | 76 | 0 | 0 | 17 | 7 | 0 |
| Example 7 | 0 | 76 | 0 | 0 | 17 | 0 | 7 |

TABLE 2

| | | Bulk | True | | Specific | | |
|---|---|---|---|---|---|---|---|
| | Thickness | density | density | Porosity | surface area | DTA | H/C |
| | mm | g/cc | g/cc | % | m²/g | ° C. | — |
| Example 1 | 0.35 | 1.13 | 1.62 | 30 | 1 | 665 | 0.01 |
| | | | | | | 727 | |
| Example 2 | 0.37 | 1.02 | 1.53 | 33 | 1 | 647 | 0.01 |
| Example 3 | 0.32 | 1.24 | 1.80 | 31 | 1 | 656 | 0.01 |
| | | | | | | 743 | |
| Example 4 | 0.35 | 1.42 | 1.88 | 25 | 1 | 650 | 0.01 |
| | | | | | | 749 | |
| Example 5 | 0.46 | 1.47 | 1.97 | 25 | 1 | 655 | 0.01 |
| | | | | | | 761 | |
| | | | | | | 809 | |
| Example 6 | 0.36 | 1.49 | 1.90 | 21 | 1 | — | 0.03 |
| Example 7 | 0.43 | 1.36 | 2.21 | 39 | 1 | — | 0.02 |
| Comparative Example 1 | 0.23 | 1.17 | 1.52 | 23 | 0.04 | 663 | 0.01 |
| Comparative Example 2 | | | | | | | |

| | Charge | Discharge | Irreversible capacity | Efficiency |
|---|---|---|---|---|
| | mAh/g | mAh/g | mAh/g | % |
| Example 1 | 423 | 376 | 47 | 89 |
| Example 2 | 449 | 394 | 54 | 88 |
| Example 3 | 360 | 321 | 40 | 89 |
| Example 4 | 327 | 268 | 59 | 82 |
| Example 5 | 330 | 308 | 22 | 93 |
| Example 6 | 598 | 554 | 45 | 93 |
| Example 7 | 359 | 332 | 27 | 92 |
| Comparative example 1 | 298 | 196 | 102 | 66 |
| Comparative example 2 | 2542 | 1010 | 1532 | 40 |

### INDUSTRIAL APPLICABILITY

The non-aqueous electrolyte secondary battery using the carbonaceous molded body for a battery electrode of the present invention has excellent non-dedoping capacity (irreversible capacity) and efficiency. Therefore, the non-aqueous electrolyte secondary battery can be used in a vehicular application such as hybrid vehicles (HEV), electric vehicles (EV), and the like, where long life and high input/output characteristics are required.

The present invention was described above using specific modes of embodiment, but modifications and improvements apparent to a person having ordinary skill in the art are also included in the scope of the present invention.

1. A carbonaceous molded body for a battery electrode, comprising:
a carbonaceous material and carbon fibers where lithium can be doped and dedoped; wherein the thickness is 1 mm or less, atomic ratio (H/C) between hydrogen atoms and carbon atoms based on elemental analysis is 0.1 or less, porosity determined from bulk density of the molded body and true density of butanol is from 25 to 80%, and volatile matter content is 5.0 wt. % or less.

2. The carbonaceous molded body for a battery electrode according to claim 1, wherein the carbonaceous material is a non-graphitizable carbonaceous material.

3. The carbonaceous molded body for a battery electrode according to claim 1, wherein the carbonaceous material is a graphitizable carbonaceous material.

4. The carbonaceous molded body for a battery electrode according to claim 1, further comprising one or more anode active material selected from the group consisting of metals that can dope and dedope lithium and metal compounds that can dope and dedope lithium.

5. The carbonaceous molded body for a battery electrode according to claim 1, wherein true density is from 1.4 to 2.20 g/cm³.

6. The carbonaceous molded body for a battery electrode according to claim 1, wherein at least one combustion peak is observed at 760° C. or lower as measured by a differential thermal analyzing device.

7. The carbonaceous molded body for a battery electrode according to claim 1, wherein the carbon fibers have an isotropic structure.

8. An electrode for a battery, comprising the carbonaceous molded body for a battery electrode according to claim 1.

9. A non-aqueous electrolyte secondary battery, comprising the electrode for a battery according to claim 8.

10. A method of manufacturing a carbonaceous molded body for a battery electrode, comprising the steps of:
(1) mixing carbon fibers and or a carbon fiber precursor thereof where lithium can be doped and dedoped, and a carbonaceous precursor to obtain a mixture;
(2) molding the mixture to obtain a molded body; and
(3) firing in order to heat treat the molded body under a non-oxidizing gas atmosphere at 1000° C. to 2000° C.

11. The method of manufacturing a carbonaceous molded body for a battery electrode according to claim 10, wherein the carbonaceous precursor is a non-graphitizable carbonaceous precursor and/or graphitizable carbonaceous precursor.

12. The method of manufacturing a carbonaceous molded body for a battery electrode according to claim 10, wherein in the aforementioned step 1, one or more anode active materials selected from the group consisting of metals that can dope and dedope lithium and metal compounds that can dope and dedope lithium is further mixed.

13. The method of manufacturing a carbonaceous molded body for a battery electrode according to claim 10, wherein the molded body in the aforementioned molding step (2) is obtained by compression molding.

14. The method of manufacturing a carbonaceous molded body for a battery electrode according to claim 10, wherein the carbon fibers have an isotropic structure.
